(19) United States
(12) Patent Application Publication
(10) Pub. No.: US 2016/0085365 A1
(43) Pub. Date: Mar. 24, 2016

(54) DISPLAY PANEL AND DISPLAY DEVICE USING THE SAME

(71) Applicant: InnoLux Corporation, Miao-Li County (TW)

(72) Inventor: Tsan-Po WENG, Miao-Li County (TW)

(21) Appl. No.: 14/857,890

(22) Filed: Sep. 18, 2015

(30) Foreign Application Priority Data
Sep. 23, 2014 (TW) 103132743

(51) Int. Cl. G06F 3/041; G09G 3/36

(52) U.S. Cl. CPC G06F 3/0416; G09G 3/3696; G06F 2203/04103; G09G 2310/0286; G09G 2320/00

(57) ABSTRACT

The disclosure provides a display device, which includes a timing controller; and a display panel connected to the timing controller, the display panel including a touch driving switch, a display driving switch, a connecting switch and a plurality of gate driving shift register circuits; wherein, at least one of the gate driving shift register circuit is electrically connected to the touch driving switch, the display driving switch and the connecting switch.

### BACKGROUND OF THE INVENTION

1. Field of the Invention

The disclosure relates to a display device and its display panel and, more particularly, to a touch display device and its touch display panel.

2. Description of Related Art

Currently, a display device, e.g. a display panel of a smart phone, is able to not only display a screen but also provide a touch control function, so as to allow a user to perform operation more easily. However, in addition to the control circuit related to screen display, the touch display device also needs a control circuit related to touch control, resulting in increased manufacturing cost and complicated circuit layout. Therefore, there is a need to provide a display device structure, which can simplify the circuit of the touch display device and reduce the manufacturing cost.

### SUMMARY OF THE INVENTION

An object of the disclosure is to provide a display panel, which includes: a touch driving switch; a display driving switch; a connecting switch; a plurality of gate driving shift register circuits; wherein at least a gate driving shift register circuit electrically connects to the touch driving switch, the display driving switch and the connecting switch. Thus, the touch control driving circuit and the display driving circuit of the display device can be integrated into the gate driving shift register circuit on the display panel.

Another object of the disclosure is to provide a display device, which includes: a timing controller; and a display panel connected to the timing controller and including a touch driving switch, a display driving switch, a connecting switch and a plurality of gate driving shift circuits; wherein, at least a gate driving shift circuit electrically connects to the touch driving switch, the display driving switch and the connecting switch. Thus, the touch control driving circuit and the display driving circuit of the display device can be integrated into the gate driving shift register circuit on the display panel; and by the integrated circuit provided by the invention, the layouts of the display device can be simplified.

Other objects, advantages, and novel features of the invention will become more apparent from the following detailed description when taken in conjunction with the accompanying drawings.

### BRIEF DESCRIPTION OF THE DRAWINGS

FIG. 1 is a schematic diagram illustrating a structure of the display device according to the disclosure;

FIG. 2(A) is a main structure diagram of the display device according to a first embodiment of the disclosure;

FIG. 2(B) is a detailed structure diagram of the gate driving shift register and the front-end circuit of the disclosure;

FIG. 3 is a timing diagram of the signals according to the first embodiment of the disclosure;

FIG. 4 is a detailed flow chart according to the first embodiment of the disclosure;

FIG. 5 is a main structure diagram of the display device according to a second embodiment of the disclosure;

FIG. 6(A) is a timing diagram of the timing control signal and the switch control signals according to the second embodiment of the disclosure;

FIG. 6(B) is a timing diagram related to the first touch and display region according to the second embodiment of the disclosure; and

FIG. 6(C) is a timing diagram related to the second touch and display region according to the second embodiment of the disclosure.

### DETAILED DESCRIPTION OF THE PREFERRED EMBODIMENT

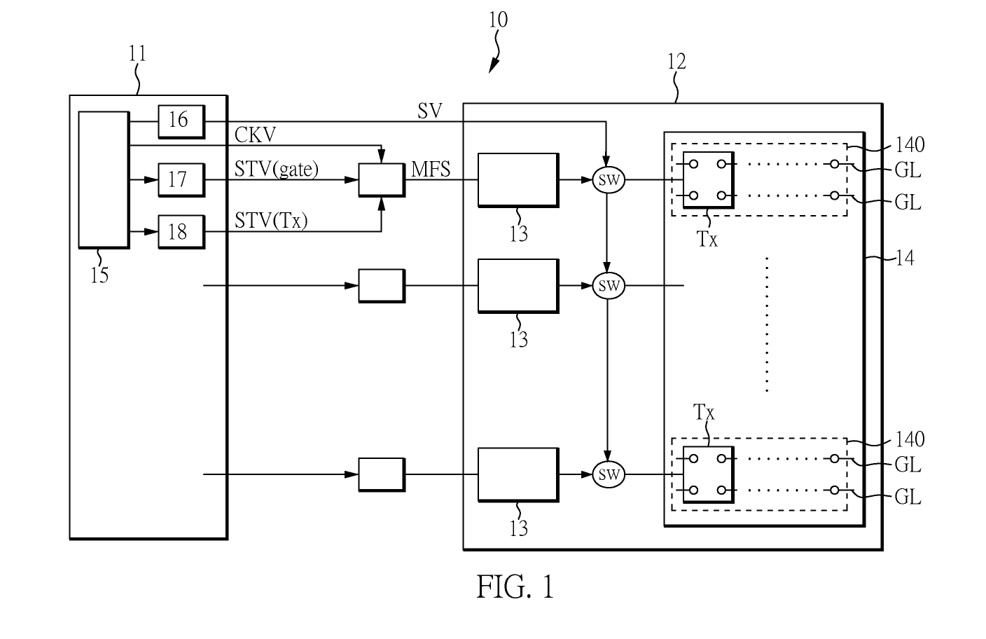

FIG. 1 is a schematic diagram of the display device according to the disclosure. The display device comprises a timing controller 11 and a display panel 12. The display panel 12 is connected to the timing controller 11, and includes a plurality of gate driving shift register circuits 13 and a touch and display region 14 having a plurality of gate lines and data lines. That is, the gate driving shift register circuits 13 are disposed on the display panel 12, wherein each of the gate driving shift register circuits 13 is connected to a gate line via a first switch SW. Besides, the display device 10 transmits a control signal to the display panel 12 by the timing controller 11 to proceed with driving of touch control and screen display. The timing controller 11 transmits at least a switch control signal SV to the first switch SW to turn on or turn off the first switch SW. The timing controller 11 further transmits a touch driving signal STV(Tx) and a gate driving signal STV(gate) to the gate driving shift register circuit 13. Furthermore, with the switch control signal SV, when the deriving of touch control is desired, the gate driving signal STV(gate) is sent to the touch and display region 14 of the display panel 12 through the first switch SW. It is noted that the time that the touch driving signal STV(TX) passes through the first switch SW and the time that the gate driving signal STV(gate) passes through the first switch SW are not overlapped.

With reference to FIG. 1 again, the touch and display region 14 is preferably divided into a plurality of touch and display segments 140, and each touch and display segment 140 has a touch driving block Tx and a plurality of gate lines GL.

The timing controller 11 has a touch and display integrated controller 15 to generate a control signal SV for the switches, and is capable of outputting a timing control signal CKV to determine the timing for the driving of touch control and screen display, and transmitting the timing control signal CKV to the first switches SW for controlling the first switches SW based on the control signal SV. Besides, the timing controller 11 also generates the touch driving signal STV(Tx) and the gate driving signal STV(gate), and transmits the driving signals and the timing control signal CKV to the gate driving shift register circuit 13 so as to compose an integrated start signal MFP. In addition, the touch and display integrated circuit 15 can be further connected to a switch control voltage level shifter 16, a gate driving voltage level shifter 17 and a touch driving voltage level shifter 18, so as to increase the voltage levels of the signals to be transmitted.

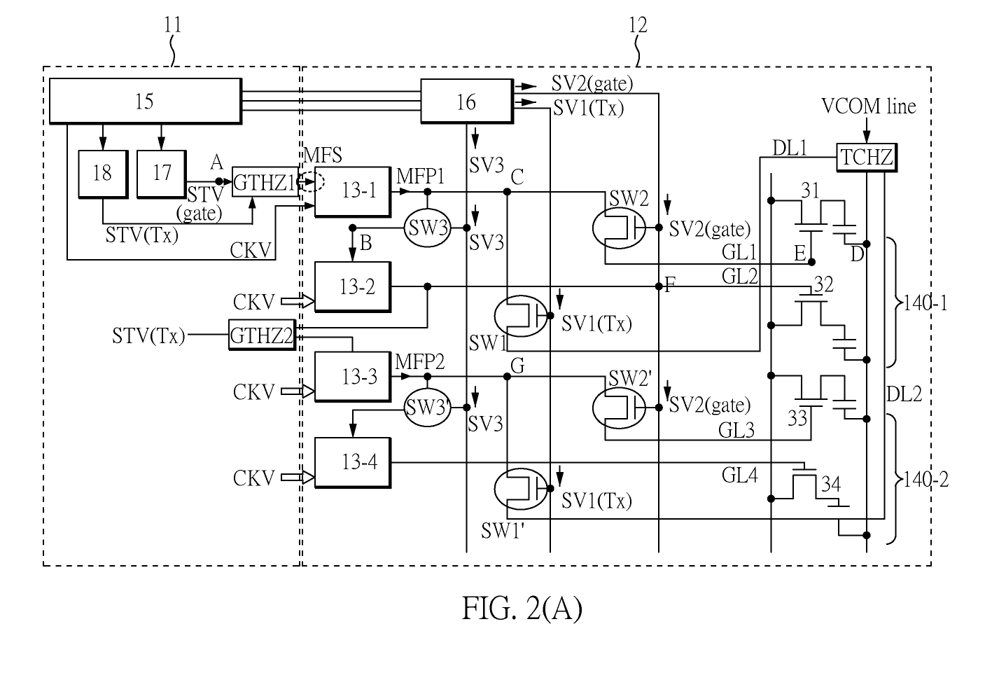

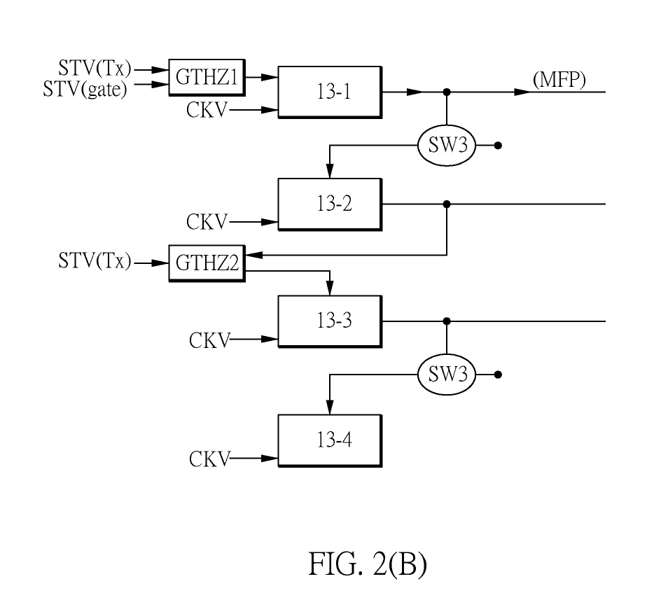

FIG. 2(A) is a main structure diagram of the display device according to a first embodiment of the disclosure. The display panel 12 has a plurality of gate driving shift register circuits 13. For more clear description, in this embodiment, two gate driving shift registers 13 corresponding to one touch and display region 140 is given as an example, and the total number of the gate driving shift registers 13 on the display panel 12 is four. However, in the actual application, each touch and display region 140 may correspond to one gate driving shift register 13 or more than two gate driving shift registers 13, and the total number of the gate driving shift registers 13 on the display panel 12 is not limited to be four. In addition, the first switch SW is preferably composed by a touch driving switch SW1 and a display driving switch SW2 for allowing the touch driving signal STV(Tx) and the gate driving signal STV(gate) to respectively pass therethrough at suitable moments. Furthermore, in addition to the touch driving switch SW1 and the display driving switch SW2, each touch and display region 140 also includes a connecting switch SW3. The connecting switch SW3 is disposed between the first gate driving shift register circuit 13-1 and the second gate driving shift circuit 13-2 for allowing the voltage level of the gate driving signal STV(gate) to pass through. That is, the first gate driving shift register circuit 13-1 transmits the voltage level of the gate driving signal STV(gate) to the second gate driving shift register circuit 13-2 via the connecting switch SW3. In fact, the second gate driving shift register circuit 13-2 is connected to the second gate line and a front-end circuit GTHZ2 of the third gate driving shift register circuit 13-3 so as to transmit the voltage level of the gate driving signal STV(gate) to the second gate line and the front-end circuit GTHZ2.

It is noted that the display panel 12 has a scan time and an interval time in displaying a frame. The touch driving switch SW1 is turned on in the interval time, and the display driving switch SW2 is turned on in the scan time.

Besides, in the first touch and display region 140-1, each of the touch driving switch SW1 and the display driving switch SW2 is preferred but not limited to be a thin film transistor. First terminals of the thin film transistors are connected to the first gate driving shift register circuit 13-1, and the other terminals of the thin film transistors are respectively connected to a data line DL1 and a gate line GL1. Similarly, in the second touch and display region 140-2, first terminals of the switch SW1′ and SW2′ are connected to the third gate driving shift register circuit 13-3, and the other terminals thereof are respectively connected to other data line DL2 and gate line GL3.

With reference to FIG. 2(A) again, the block on the left-top corner is the touch and display integrated controller 15, which has a first path connected to the gates of all touch driving switch SW1 on the display panel 12 and a second path connected to the gates of all touch display driving switch SW2 on the display panel 12, so as to transmit the switch control signal SV for controlling the switches to be turned on. Besides, the touch and display integrated controller 15 further includes a third path and a fourth path connected to the first gate driving shift register circuit 13-1, so as to transmit the touch driving signal STV(Tx), the gate driving signal STV(gate) and the timing control signal CKV to the first gate driving shift register circuit 13-1 for being integrated into an integrated start signal MFP1.

FIG. 2(B) is a detailed structure diagram illustrating the gate driving shift register circuits 13-1 to 13-4 and the front-end circuits GTHZ1 to GTHZ2 according to the disclosure. As shown in FIG. 2(B), the touch driving signal STV(Tx) and the gate driving signal STV(gate) are first integrated in the front-end circuit GTHZ1, and then integrated with the timing control signal CKV in the first gate driving shift register circuit 13-1 so as to form the integrated start signal MFP1. Then, the first gate driving shift register circuit 13-1 transmits a part of the integrated start signal MFP1 related to the gate driving signal STV(gate) to the second gate driving shift register circuit 13-2, and the part of the integrated start signal MFP1 is integrated with the timing control signal CKV at a suitable time for being outputted to the other front-end circuit GTHZ2. The front-end circuit GTHZ2 integrates the part of the integrated start signal MFP 1 related to the gate driving signal STV(gate) with an external touch driving signal STV(Tx), which is further integrated with the timing control signal CKV in the third gate driving shift register circuit 13-3, so as to form an integrated start signal MFP2.

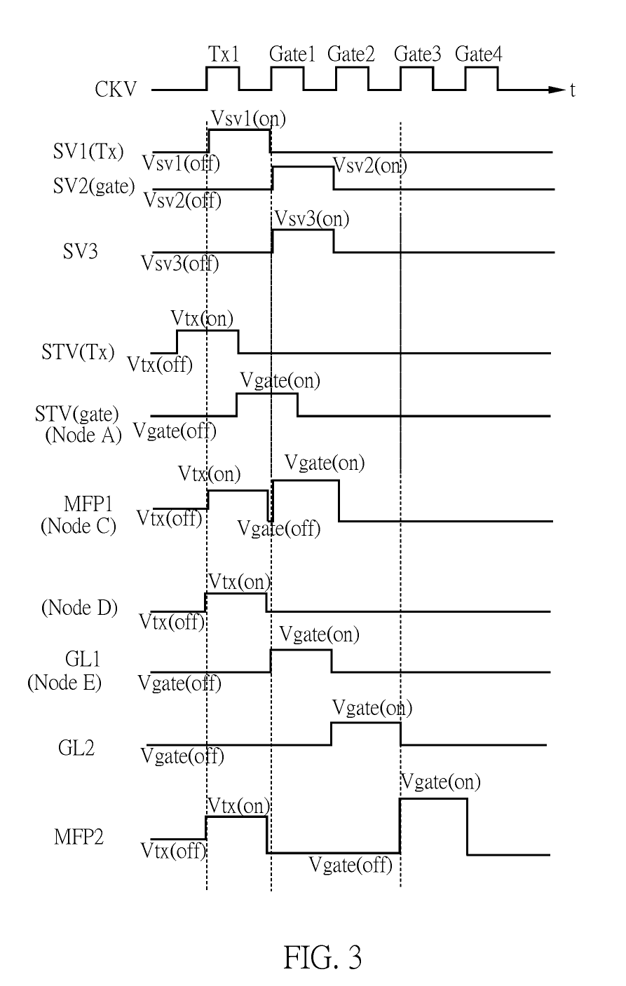

FIG. 3 is a timing diagram of the signals in the first embodiment. With reference to both FIG. 3 and FIG. 2(A), in this embodiment, the first touch and display region 140-1 includes two gate lines GL1 and GL2 respectively corresponding to the first gate driving shift register circuit 13-1 and the second gate driving shift register circuit 13-2. FIG. 3 is used to illustrate the timing variations of the signals on a plurality of nodes A, C, D and E of FIG. 2(A), and the statuses of the nodes are described hereinafter.

Node A is first described, which is disposed at a position where the gate driving signal STV(gate) transmitted by the touch and display integrated controller 15 and boosted by the gate driving voltage level shifter 17 is to be inputted to the front-end circuit GTHZ1. As shown in FIG. 3, the gate driving signal STV(gate) has a gate driving voltage level (Vgate(off) to Vgate (on)). Similarly, the touch driving signal STV(Tx) is boosted by the touch driving voltage level shifter 18 for being inputted to the front-end circuit GTHZ1, and has a touch driving voltage level, ((Vtx(off) to Vtx(on). The front-end circuit GTHZ1 combines the touch driving voltage level and the gate driving voltage level to form a start signal MFS, and inputs the start signal MFS and the timing control signal CKV to the first gate driving shift register circuit 13-1, so as to obtain an operation timing for composing the integrated start signal MFP1.

Besides, in FIG. 2(A), Node B is positioned between the connecting switch SW3 and the second gate driving shift register circuit 13-2. When the timing of the timing control signal CKV is proceeding to the first gate driving timing pulse, denoted as Gate1, a gate driving voltage level (Vgate(off) to Vgate(on)) in the integrated start signal MFP1 just passes through Node B.

Node C is positioned on an output terminal of the first gate driving shift register circuit 13-1, and connected to the touch driving switch SW1, the display driving switch SW2 and the connecting switch SW3. That is, the signal timing diagram of Node C is equivalent to the signal timing diagram of the integrated start signal MFP1. As shown in the signal timing diagram of Node C, when the timing of the timing control signal CKV is proceeding to a touch driving timing pulse Tx1, the touch driving switch SW1 is turned on by receiving a voltage level of a touch driving switch control signal SV1(TX) (Vsv1(off) to Vsv1(on)), and thus the touch driving voltage level (Vtx(off) to Vtx(on)) in the integrated start signal MFP1 passes through the touch driving switch SW1, so that the touch driving voltage level (Vtx(off) to Vtx(on)) exists in the timing of Node C. When the timing of the timing control signal CKV is proceeding to a first gate driving timing pulse Gatel, the display driving switch SW2 is turned on by receiving a voltage level (Vsv2(off) to Vsv2(on)) of a display driving switch control signal SV2(gate), and the connecting switch SW3 receives a voltage level (Vsv3(off) to Vsv3(on)) of a connecting switch control signal VS3, so that the gate driving voltage level (Vgate(off) to Vgate(on)) in the integrated start signal MFP1 passes through the display driving switch SW2 and the connecting switch SW3, and thus the gate driving voltage level (Vgate(off) to Vgate(on)) exists in the timing of Node C.

Node D is positioned on a common electrode line (VCOM line), the common electrode line is connected to a data line DL1 connected with the touch driving switch SW1 so as to receive the touch driving voltage level in the integrated start signal MFP1. Then, the touch driving voltage level is coupled to at least a touch receiving terminal (not shown) by the common electrode line. Thus, when the timing of the timing control signal CKV is proceeding to a touch driving timing pulse Tx1, the touch driving voltage level (Vtx(off) to Vtx(on)) exists on the Node D.

Node E is positioned between a first gate line GL1 connected to the display driving switch SW2 and a first pixel unit 31. The first pixel unit 31 receives the gate driving voltage level in the integrated start signal MFP1 to drive the first gate line GL1 to proceed with scanning. Therefore, when the timing of the timing control signal CKV is proceeding to a first gate driving timing pulse Gatel, the gate driving voltage level (Vgate(off) to Vgate(on)) exists on the Node E.

Besides, on Node F of FIG. 2(A), the second gate driving shift register circuit 13-2 not only receives the gate driving voltage level (Vgate(off) to Vgate(on)) in the integrated start signal MFP1, but also receives the timing control signal CKV from outside, and transmits the gate driving voltage level (Vgate(off) to Vgate(on)) to a first pixel unit 32 on the second gate line GL2 when the timing of the timing control signal CKV is proceeding to a second gate driving timing pulse Gate2, and thus the second gate line GL2 is driven for scanning.

Thus, the operation of the first touch and display region 140-1 can be completed. It is noted that, although the first touch and display region 140-1 in this embodiment has two gate lines, it may have more gate lines in actual application. Moreover, it is not limited that one gate driving shift register circuit controls one gate line. In actual application, one gate driving shift register circuit may control a plurality of gate lines.

With reference to FIG. 3 and FIG. 2(A) again, the touch and display region 140-2 includes two gate lines, and one gate driving shift register circuit controls one gate line. When the timing of the timing control signal CKV is proceeding to the second gate driving timing pulse Gate2, the second gate driving shift register circuit 13-2 not only transmits the gate driving voltage level (Vgate(off) to Vgate(on)) to the second gate line GL2, but also transmits the gate driving voltage level (Vgate(off) to Vgate(on)) to the front-end circuit GTHZ2 of the third gate driving shift register circuit 13-3. The front-end circuit GTHZ2 combines the gate driving signal STV(gate) and the touch driving signal STV(Tx) from the touch and display integrated controller 15 to form the start signal MFS, and the start signal MFS and the timing control signal CKV are inputted to the third gate driving shift register circuit 13-3 to form the second integrated start signal MFP2.

Node G is positioned on the output terminal of the third gate driving shift register circuit 13-3. That is, the signal passing through Node G is the integrated start signal MFP2, and Node G is connected to the touch driving switch SW1′, the display driving switch SW2′ and the connecting switch SW3′. As shown in FIG. 3(C), when the timing of the timing control signal CKV is proceeding to the touch driving timing pulse Tx1, the switch SW1′ is turned on, so that the touch driving voltage level (Vtx(off) to Vtx(on) passes through the touch driving switch SW1′ and exists on Node G When the timing of the timing control signal CKV is proceeding to a third gate driving timing pulse Gate 3, the switches SW2′ and SW3′ are turned on, so that the gate driving voltage level (Vgate(off) to Vgate(on)) passes through the display driving switch SW2′ and the connecting switch SW3′ and exists on Node G At this moment, a first pixel unit 33 on the third gate line GL3 connected to the switch SW2′ receives the gate driving voltage level, so as to drive the third gate line GL3 for scanning. Therefore, the gate driving voltage level (Vgate(off) to Vgate(on)) also exists in the timing of the third gate line GL3.

Similar to the second gate driving shift register circuit 13-2, the fourth gate driving shift register circuit 13-4 not only receives the gate driving voltage level, but also receives the timing control signal CKV. When the timing of the timing control signal CKV is proceeding to a fourth gate driving timing pulse Gate4, the gate driving voltage level is inputted to a first pixel unit 34 on the fourth gate line GL4, so that the gate driving voltage (Vgate(off) to Vgate (on)) exists in the timing of the fourth gate line GL4.

It is noted that the second touch and display region 140-2 also has a touch switch SW1′, and the touch switch SW1′ and the touch switch SW1 in the first touch and display region 140-1 are turned on at the same time. Due to that the touch driving is generated only in the interval time of the frame in the disclosure, the touch driving switches SW1 and SW1′ in the touch and display regions are turned on at the same time when the frame is changed, and are turned off when the gate lines start to proceed with scanning.

Besides, the display driving switches (SW2, SW2′) and the connecting switches (SW3, SW3′) also can be turned on at the same time, but the disclosure is not limited thereto.

It is noted that the turn-on time of the touch driving switches (SW1, SW1′) and the turn-on time of the connecting switches (SW3, SW3′) are not overlapped.

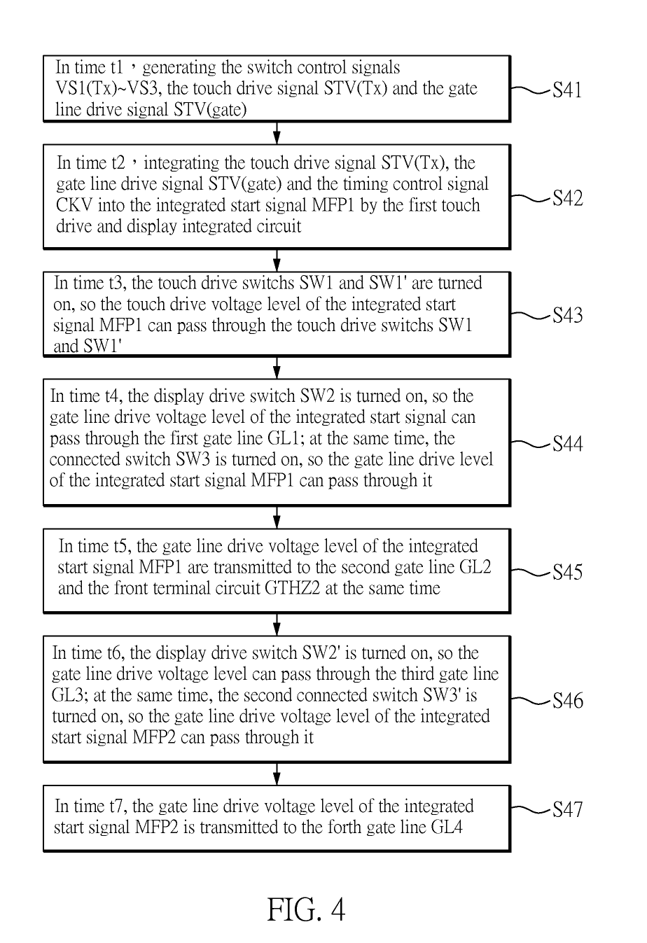

With reference to FIG. 4 and FIG. 3, FIG. 4 is a detailed flow chart according to the first embodiment of the invention. In a time t1, the touch and display integrated controller 15 generates the control signals SV1(Tx) to SV3 of the switches SW1 to SW3, the touch driving signal STV(Tx), and the gate driving signal STV(gate). In a time t2 following the time t1, the control signals SV1(Tx) to SV3 of the switches SW1 to SW3 are boosted and transmitted, the touch driving signal STV(Tx) and the gate driving signal STV(gate) are boosted and transmitted to the first gate driving shift register circuit 13-1 with the timing control signal CKV, and the boosted touch driving signal STV(Tx) and the timing control signal CKV are transmitted to the third gate driving shift register circuit 13-3.

In a time t3 following the time t2 (i.e., when the timing of the timing control signal CKV is proceeding to the touch driving timing pulse Tx1), all touch driving switches (SW1, SW1′) on the display panel 12 receive the touch driving switch control signal SV1(Tx) and thus are turned on, so that the touch driving voltage level transmitted from the first gate driving shift register circuit 13-1 and the third gate driving shift register circuit 13-3 can pass through the touch driving switch SW1 for being inputted to the touch and display region 14 of the display panel 12. In a time t4 following the time t3 (i.e., when the timing control signal CKV is proceeding to the first gate driving timing pulse Gate 1), the display driving switch SW2 connected to the first gate line GL1 receives the display driving switch control signal SV2(gate) and thus is turned on, so that the gate driving voltage level transmitted from the first gate driving shift register circuit 13-1 passes through the display driving switch SW2 for being inputted to the first gate line GL1. In the time t4, the connecting switch SW3 connected to the first gate driving shift register circuit 13-1 is also turned on by receiving the connecting switch control signal SV3, and thus the gate driving voltage level transmitted by the first gate driving shift register circuit 13-1 passes through the connecting switch 3 for being transmitted to the second gate driving shift register circuit 13-2. In a time t5 following the time t4 (i.e., when the timing control signal CKV is proceeding to the second gate driving timing pulse Gate 2), the second gate driving shift register 13-2 transmits the gate driving voltage level to the second gate line GL2 and the third gate driving shift register circuit 13-2.

In a time t6 following the time t5 (i.e., when the timing control signal CKV is proceeding to the third gate driving timing pulse Gate 3), the display driving switch SW2 connected to the third gate line GL3 is turned on by receiving the display driving switch control signal SV2(Tx), and the third gate driving shift register circuit 13-3 transmits the gate driving voltage level to the third gate line GL3. At the same time, the third switch SW3 connected to the fourth gate shift register circuit 13-4 is turned on by receiving the connecting switch control signal SV3, and thus the gate driving voltage level can be transmitted to the fourth gate driving shift register circuit 13-4. In a time t7 following the time t6 (i.e., when the timing control signal CKV is proceeding to the fourth gate driving timing pulse Gate 4), the fourth gate driving shift register circuit 13-4 transmits the gate driving voltage level to the fourth gate line GL4. Thus, the operation flow for a touch driving and a screen display can be completed. While in a subsequent time t8 following the time t7, the step of turning on the touch driving switch SW1 in the time t3 is executed again (or the steps in time t1 to time t3 are executed again); i.e., from the time t8, an operation flow for the next touch driving and screen display starts.

Accordingly, the first embodiment of the disclosure integrates the touch driving circuit and the gate driving circuit and disposed the same directly on the display panel of the display device to reduce overall cost of the system, and simplifies the circuit layout via arrangement of the timing.

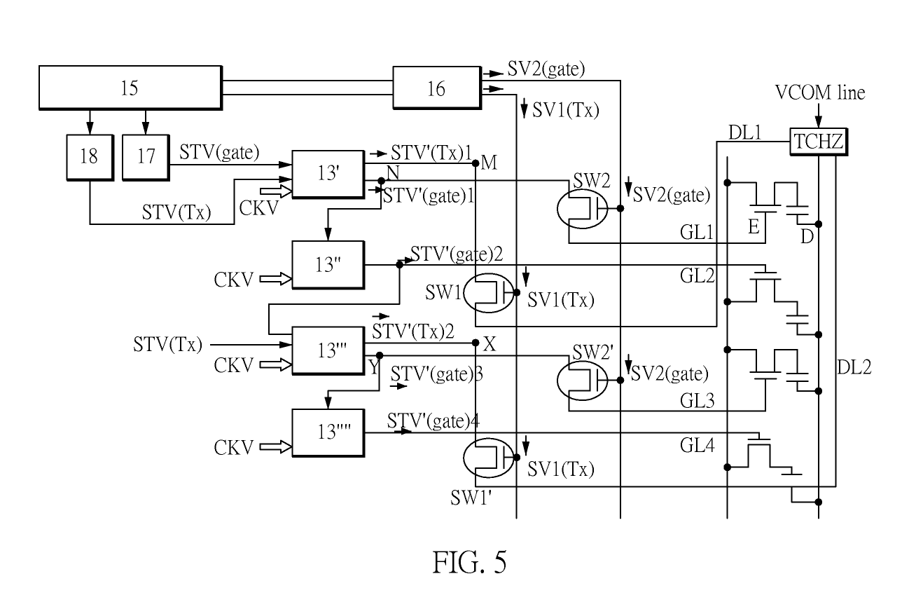

FIG. 5 is a main structure diagram of the display device according to a second embodiment of the disclosure. In this embodiment, two gate driving shift register circuits 13 corresponding to a touch and display region 140-1 is taken as an example, and the total number of the gate driving shift register circuits 13 is 4, but the disclosure is not limited thereto. Similar to the first embodiment, the first switch SW is preferably composed by a touch driving switch SW1 and a display driving switch SW2 for allowing a voltage level of the touch driving signal STV(Tx) and a voltage level of the gate driving signal STV(gate) to respectively pass therethrough at suitable moments. Different from the first embodiment, the second embodiment does not have the connecting switch SW3 due to that the gate driving shift register circuits in the second embodiment transmit the touch driving voltage level and the gate driving voltage level via different paths. That is, a gate driving shift register circuit is directly connected to the next gate driving shift register circuit via the path of transmitting the gate driving voltage level. Because different paths are respectively used, there is no need to integrate the touch driving signal STV(Tx) with the gate driving signal STV(gate) and thus the front-end circuits GTHZ are no longer required. Instead, it only requires integrating the touch driving signal STV(Tx) and the gate driving signal STV(gate) with the timing control signal CKV, respectively, on the gate driving shift register circuit.

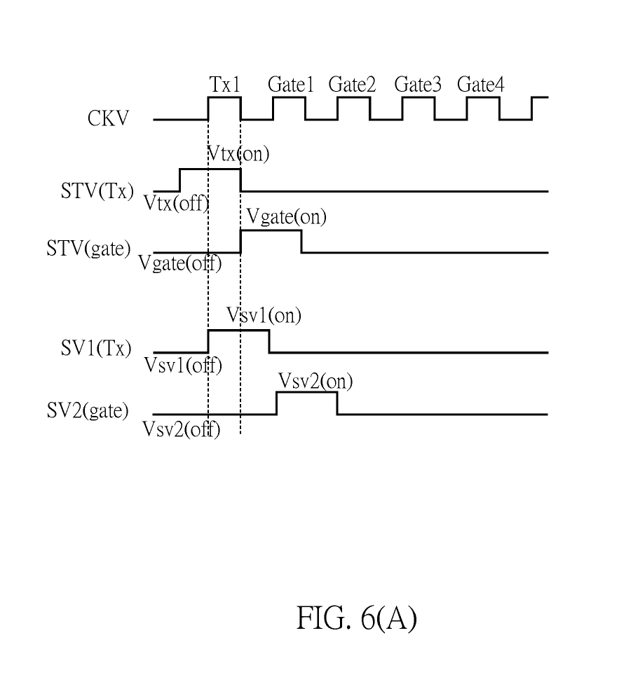

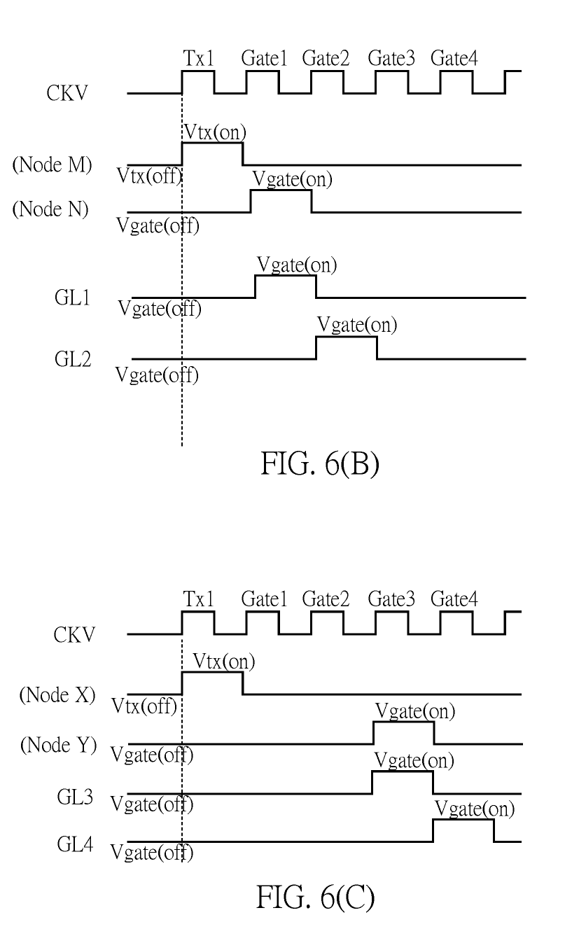

FIG. 6(A) is the timing diagram for the timing control signal CKV and switch control signals SV1(Tx) to SV2(gate) in the second embodiment. The timing control signal CKV is composed by a touch driving timing pulse Tx1 and a plurality of gate driving timing pulses Gate1 to Gate 4 in sequence. Besides, a touch driving switch control signal SV1(Tx) corresponds to a touch driving timing pulse Tx1 of the timing control signal CKV, so as to generate a control voltage to turn on the touch driving switch SW1 synchronously. The display driving switch control signal SV2(gate) corresponds to the first gate driving timing pulse Gate1, so as to generate a control voltage to turn on the display driving switch SW2 synchronously.

FIG. 6(B) is a timing diagram related to the first touch and display region 140-1 in the second embodiment. At first, node M is described, which is disposed on a path with which the first gate driving shift register circuit 13-1 is connected to the touch driving switch SW1. The first gate driving shift register circuit 13-1 integrates the timing control signal CKV and the touch driving signal STV(Tx) to form an integrated touch driving signal STV′(Tx)1, which passes through the touch driving switch SW1 for being transmitted to the coupled line VCOM via a first data line DL1. Therefore, when the timing control signal CKV is proceeding to the touch driving timing pulse Tx1, the touch driving voltage level (VTx(off) to VTx(on)) exists on the timing of Node M. Node N is disposed on a path with which the first gate driving shift register circuit 13-1 is connected to the display driving switch SW2 and the second gate driving shift register circuit 13-2. The first gate driving shift register circuit 13-1 integrates the timing control signal CKV and the gate driving signal STV(gate) into an integrated gate driving signal STV′(gate)1, which passes through the touch driving switch SW1 for being transmitted to the first gate line GL1, and the first gate driving shift circuit 13-1 also transmits the integrated gate driving signal STV′(gate)1 to the second gate driving shift register circuit 13-2, so that, when the timing control signal CKV is proceeding to the first gate driving timing pulse Gatel, the gate driving voltage level (Vgate(off) to Vgate(on)) exists on the timing of Node N. At the same time, the gate driving voltage level (Vgate(off) to Vgate(on)) exists on the timing of the first gate line GL1. Besides, when the timing control signal CKV is proceeding to the second gate driving timing pulse Gate2, the second gate line GL2 receives the gate driving signal STV′(gate)2 from the second gate driving shift register circuit 13-2, and the second gate driving shift register circuit 13-2 transmits the gate driving voltage level to the third gate driving shift register circuit 13-3.

FIG. 6(C) is a timing diagram related to the second touch and display region in the second embodiment. Similar to FIG. 6(B), when the timing control signal CKV is proceeding to the touch driving timing pulse Tx1, the touch driving voltage level (VTx(off) to VTx(on)) exists on the timing of Node X. When the timing control signal CKV is proceeding to the third gate driving timing pulse Gate3, the gate driving voltage level (Vgate(off) to Vgate (on)) exists on the timing of Node Y and, at the same time, the gate driving voltage level signal (STV′(gate)3) exists on the timing of the third gate line GL3. When the timing control signal CKV is proceeding to the fourth gate driving timing pulse Gate4, the fourth gate line GL4 receives the gate driving voltage level (STV′(gate)4) from the fourth gate driving shift register circuit 13-4, so that there is the gate driving voltage level (Vgate(off) to Vgate (on)) existed on its timing.

Accordingly, with the second embodiment of the disclosure, the touch driving circuit and the display driving circuit can be respectively disposed on the display panel of the display device to reduce the total cost of the system, and to achieve the effect of simplifying the circuit layout by arrangement of timing.

Although the disclosure has been explained in relation to its preferred embodiment, it is to be understood that many other possible modifications and variations can be made without departing from the spirit and scope of the invention as hereinafter claimed.

What is claimed is:

1. A display panel, comprising:
a touch driving switch;
a display driving switch;
a connecting switch; and
a plurality of gate driving shift register circuits,
wherein at least one of the gate driving shift register circuits is electrically connected to the touch driving switch, the display driving switch and the connecting switch.

2. The display panel of claim 1, wherein at least one of the gate driving shift register circuits further transmits a gate driving signal to another gate driving shift register circuit via the connecting switch.

3. The display panel of claim 2, wherein the connecting switch has a turn-on time which is not overlapped with that of the touch driving switch.

4. The display panel of claim 1, wherein the display panel has a scan time and an interval time in displaying an image.

5. The display panel of claim 4, wherein the touch driving switch is turned on in the interval time.

6. The display panel of claim 4, wherein the display driving switch is turned on in the scan time.

7. The display panel of claim 1, further comprising a switch control voltage level shifter for outputting a touch driving switch control signal and a display driving switch control signal to the touch driving switch and the display driving switch, respectively.

8. A display device, comprising:
a timing controller; and
a display panel connected to the timing controller and including a touch driving switch, a display driving switch, a connecting switch, and a plurality of gate driving shift register circuits,
wherein at least one of the gate driving shift register circuits is electrically connected to the touch driving switch, the display driving switch and the connecting switch.

9. The display device of claim 8, wherein at least one of the gate driving shift register circuits further transmits a gate driving signal to another gate driving shift register circuit via the connecting switch.

10. The display device of claim 8, wherein the connecting switch has a turn-on time which is not overlapped with that of the touch driving switch.
